(19) United States
(12) Patent Application Publication
(10) Pub. No.: US 2004/0149775 A1
(43) Pub. Date: Aug. 5, 2004

(54) Cosmetic container having double chamber

(76) Inventor: Szu-Chang Chen, Junghe City (TW)

Correspondence Address: PRO-TECHTOR INTERNATIONAL, 20775 Norada Court, Saratoga, CA, 95070-3018, US

(21) Appl. No.: 10/356,196

(22) Filed: Jan. 30, 2003

(51) Int. Cl. B67D 5/52

(52) U.S. Cl. 222/135

(57) ABSTRACT

A cosmetic container for dispensing a soft cosmetic mass is disclosed. The container comprises two mated upright chambers, each chamber including a top external threaded section and a protrusion in an underside, two push rods each including an enlarged knob having inner threads threadedly secured to the threaded section, and a top spring biased trigger put on the push rods, a shroud including two top apertures for permitting the push rods to insert through and two opposite inner latches in a bottom, the latches being disposed under bottom edges of the knobs for supporting and fastening, a bottom disk including two spaced holes with the protrusions matingly engaged therein, and a cap. In use an equal amount of soft mass can be squeezed out of both chambers in one dispense.

### FIELD OF THE INVENTION

The present invention relates to cosmetic containers and more particularly to a cosmetic container having two mated chambers so that an equal amount of soft mass can be squeezed out of both chambers in one dispense.

### BACKGROUND OF THE INVENTION

There is a type of cosmetic product sold in two separate containers. In use, a user has to squeeze out a soft mass from each container prior to mixing them together by hands. However, the prior art suffered from a couple of disadvantages. For example, the user may not find either container in use because they may be stored in different places. Also, it is often that one container is empty while the other one is not because typically the amount of mass squeezed out of one container is not the same as that of the other container in one dispense. Hence, the desired beautifying effect the cosmetic product is compromised. Hence, a need for improvement exists.

### SUMMARY OF THE INVENTION

It is therefore an object of the present invention to provide a cosmetic container having two mated chambers so that an equal amount of soft mass can be squeezed out of both chambers in one dispense.

To achieve the above and other objects, the present invention provides a cosmetic container for dispensing a soft cosmetic mass, the cosmetic container comprising two mated upright chambers each for containing a cosmetic mass, each chamber including a top surface, an external threaded section extended from the top surface, a bottom surface, and a protrusion projected downward from the bottom surface; two push rods each including a lower tube inserted into the chamber, an upper tube, an enlarged knob between the tubes, the knob having inner threads threadedly secured to and held by the threaded section, and a top spring biased trigger put on the upper tubes; a shroud including two top apertures for permitting the upper tubes to insert through and two opposite inner latches in a bottom, the latches being disposed under bottom edges of the knobs for supporting the knobs and fastening upper portions of the chambers; a bottom disk including two spaced holes with the protrusions matingly engaged therein for fastening lower portions of the chambers; and a cap put on the top surfaces. In use an amount of the cosmetic mass squeezed from one push rod is the same as that of the other push rod in one dispensing in response to a pressing of the trigger.

The above and other objects, features and advantages of the present invention will become apparent from the following detailed description taken with the accompanying drawings.

### BRIEF DESCRIPTION OF THE DRAWINGS

FIG. 1 is an exploded view of a first preferred embodiment of cosmetic container according to the invention;

FIG. 2 is a perspective view in part section of the container of FIG. 1 after assembled;

FIG. 3 is a perspective view of shroud shown in FIG. 1; and

FIG. 4 is an exploded view of a second preferred embodiment of cosmetic container according to the invention.

### DETAILED DESCRIPTION OF THE PREFERRED EMBODIMENTS

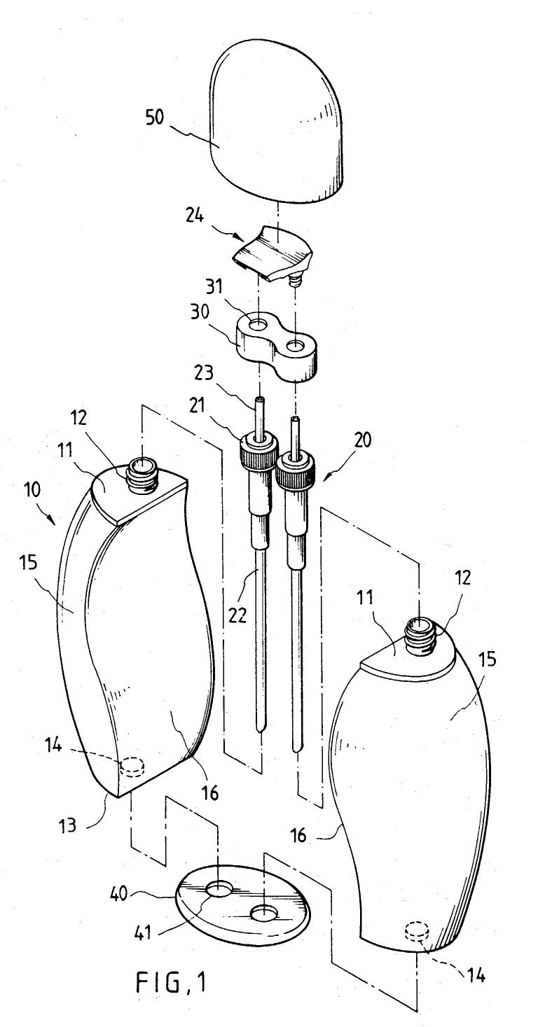

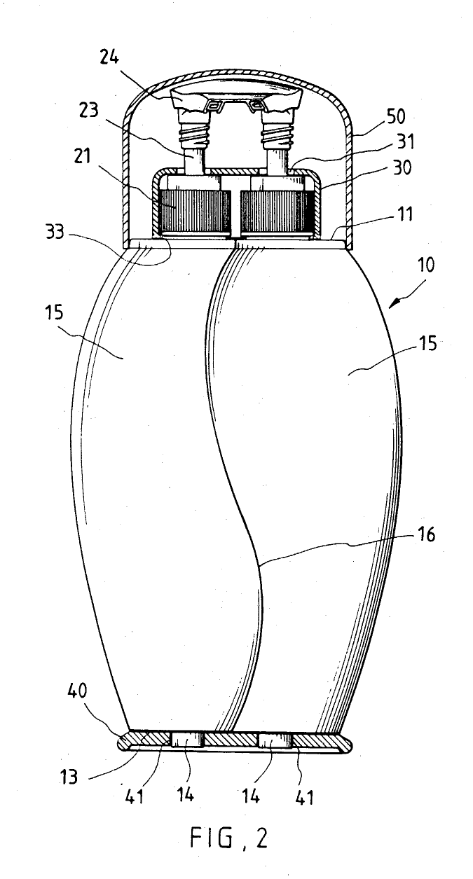

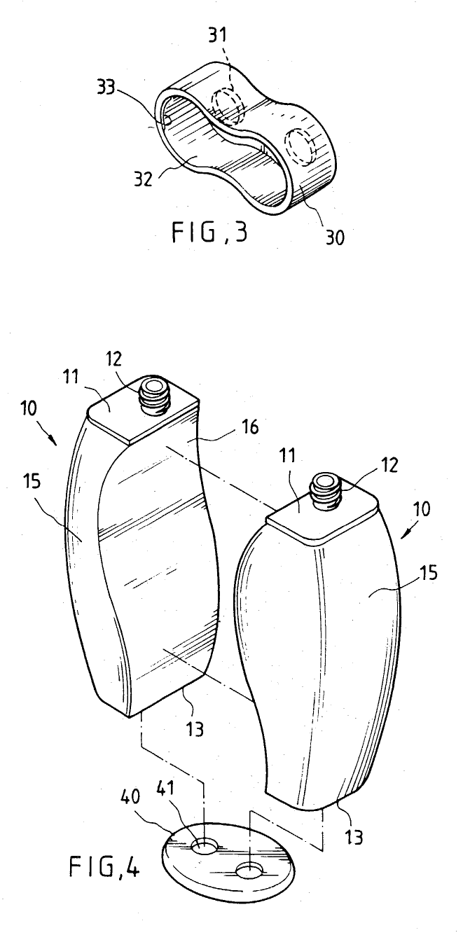

Referring to FIGS. 1, 2, and 3, there is shown a cosmetic container constructed in accordance with a first preferred embodiment of the invention. The container comprises two upright chambers 10 each for containing a cosmetic mass, each chamber 10 including a top surface 11, an external threaded section 12 extended from the top surface 11, a bottom surface 13, a protrusion 14 projected downward from the bottom surface 13, an arcuate outer surface 15, and an arcuate inner surface 16 mated with that of the other chamber 10 so that the chambers 10 can be matingly engaged; two push rods 20 each including a lower tube 22 inserted into the chamber 10, an upper tube 23, an enlarged knob 21 between the tubes 22 and 23, the knob 21 having inner threads (not shown) threadedly secured to and held by the threaded section 12, and a top trigger 24 having two downward spring members put on the upper tubes 23 for making the trigger 24 as a spring biased pivotal means; a shroud 30 including two top apertures 31 for permitting -the upper tubes 23 to insert through and two opposite latches 33 in the bottom of an inner surface 32, the latches 33 being disposed under the bottom edges of the knobs 21 for supporting the knobs 21 and fastening the upper portions of the chambers 10; a bottom disk 40 having two spaced holes 40 with the protrusions 14 matingly engaged therein for fastening the lower portions of the chambers 10; and a cap 50 put on the top surfaces 11 for protecting upper components such as the trigger 24 and the shroud 30.

In use, the user can press the trigger 24 downward to cause the lower tubes 22 to suck cosmetic mass from the chambers 10. As a result, the cosmetic mass is flowed to the outside via the upper tubes 23 in a well-known manner. The feature of the invention is that an equal amount of cosmetic mass is squeezed out of both chambers 10 in one dispense.

Referring to FIG. 4, there is shown a second preferred embodiment of the container according to the invention. The second preferred embodiment substantially has same structure as the first preferred embodiment. The characteristic of the second preferred embodiment is the shape of the chamber 10. As shown, the top surface 11 of the chamber 10 is rectangular as different from the half-circular one shown in the first embodiment.

While the invention has been described by means of specific embodiments, numerous modifications and variations could be made thereto by those skilled in the art without departing from the scope and spirit of the invention set forth in the claims.

What is claimed is:

1. A cosmetic container for dispensing a soft cosmetic mass, the cosmetic container comprising:
two mated upright chambers each for containing a cosmetic mass, each chamber including a top surface, an external threaded section extended from the top surface, a bottom surface, and a protrusion projected downward from the bottom surface;
two push rods each including a lower tube inserted into the chamber, an upper tube, an enlarged knob between the tubes, the knob having inner threads threadedly secured to and held by the threaded section, and a top spring biased trigger put on the upper tubes;
a shroud including two top apertures for permitting the upper tubes to insert through and two opposite inner latches in a bottom, the latches being disposed under bottom edges of the knobs for supporting the knobs and fastening upper portions of the chambers;
a bottom disk including two spaced holes with the protrusions matingly engaged therein for fastening lower portions of the chambers; and
a cap put on the top surfaces;
wherein in use an amount of the cosmetic mass squeezed from one push rod is the same as that of the other push rod in one dispensing in response to a pressing of the trigger.
